(19) United States
(12) Patent Application Publication
(10) Pub. No.: US 2005/0254652 A1
(43) Pub. Date: Nov. 17, 2005

(54) Automated network security system and method

(76) Inventors: Haim Engler, MA'ALE ADUMIM (IL); Drew Tick, Jerusalem (IL)

Correspondence Address: GORDON & REES LLP, 101 WEST BROADWAY, SUITE 1600, SAN DIEGO, CA, 92101, US

(21) Appl. No.: 10/521,429

(22) PCT Filed: Jul. 14, 2003
(86) PCT No.: PCT/IL03/00579

§ 371 Date: Jan. 13, 2005

Related U.S. Application Data
(60) Provisional application No. 60/396,507, filed on Jul. 16, 2002.

(51) Int. Cl. H04K 1/00

(52) U.S. Cl. 380/270

(57) ABSTRACT

A method is presented for automatically providing a secure connection between a wireless network including a server and server software installed thereon and a device seeking access to the wireless network. In response to an initial request for access to the wireless network by the device, a software agent is installed on the device which gathers identification information from the device and prompts the user to provide authentication information which is transmitted to the server. If successfully verified, the server stores the identification and authentication information in an authorized access list, provides a unique encryption key to the requesting device and grants the authenticated user and identified device access to the wireless network. The method also includes procedures for when authentication fails and for granting subsequent access to an authenticated device and user.

### TECHNICAL FIELD

The present invention relates generally to wireless communication networks and, more particularly, to systems and methods for automatically providing secure communications between devices over a wireless network.

### BACKGROUND ART

Implementation of wireless local area networks (LANs) based on the IEEE 802.11 standard has gained wide acceptance. When installed in their default mode, wireless LANs (WLANs) are inherently insecure due to a lack of user authentication and data encryption. WLAN access points (APs), which provide wireless devices entry to wired networks, and wireless network interface cards (WNICs), which equip a device for wireless communication, can be obtained from multiple vendors. Since APs and WNICS are made by multiple manufacturers, they generally do not include authentication certificates or other identifiers which are found in other wireless devices such as, for example, cellular phones. However, APs and WNICs do include a unique hardware identifier for the device in the form of a media access control (MAC) address.

In cellular telephone networks, both base station and mobile stations are manufactured by a limited group of vendors and manufacturers. Additionally, the cellular networks are made up of a standardized configuration. These factors make it relatively easy to coordinate hardware-based authentication and encryption. In contrast, for wireless IEEE 802.11 LANs there are over fifty device vendors, multiple manufacturers, and a large number of possible network configurations. Accordingly, it is a far greater challenge to authenticate valid users and enable data encryption in IEEE 802.11 wireless networks.

The WLAN standard, as defined by the IEEE 802.11 specification, defines two authentication algorithms for 802.11-based networks. A first form of authentication is referred to as an Open System method. The Open System employs a null authentication algorithm in that any station requesting authentication is granted access. A second form of authentication is referred to as a Shared Key Mode System method. The Shared Key Mode System requires that both a requesting station and a granting station are configured with matching encryption keys. For example, the requesting station sends an authentication request to the granting station. The granting station sends a plain text challenge frame to the requesting station. The requesting station encrypts the challenge frame and sends it back to the granting station. The granting station attempts to decrypt the frame, and if the resulting plain text matches what the granting station originally sent, then the requesting station has a valid key and is granted access.

The inventors have realized that the process of configuring a Shared Key Mode system typically requires human intervention and, as such, is inefficient. Accordingly, there is a need for an improved method for automatically providing secure communications between devices over a wireless network.

### SUMMARY OF THE INVENTION

Accordingly, it is an object of the present invention to provide a system and method for automatically providing secure communications over a wireless network.

It is another object of this invention to provide a system and method for automatically reconfiguring an Open System into a Shared Key Mode System by requiring minimal, if any, human intervention.

Further objects of this invention will become more apparent from a consideration of the drawings and ensuing description.

The above and other objects are achieved by a system and method for automatically providing a secure connection between a wireless network and a device seeking access to the wireless network. The wireless network includes a server and a software agent installed on the server. In response to an initial request for access to the wireless network by the device, the method includes automatically installing the software agent on the requesting device; executing the software agent on the requesting device to gather identification information from the device, prompting a user of the device to provide authentication information and transmitting the identification and authentication information to the server. The server verifies the identification and authentication information. When successfully verified, the server stores the identification and authentication information on an authorized access list, provides a unique key to the requesting device and grants the device access to the wireless network. When unsuccessfully verified, the server stores the identification and authentication information on an unauthorized access list and denies the requesting device access to the wireless network. In response to a subsequent request for access to the wireless network by the device, the method includes receiving the unique key corresponding to the requesting device; retrieving the identification and authentication information corresponding to the unique key; comparing the identification and authentication information with the authorized and unauthorized lists; and based on the comparison, granting or denying the requesting device access to the wireless network.

In one embodiment, when denying a requesting device access, the server generates a notification message that an unauthorized device has attempted to access the wireless network. In another embodiment, when granting a requesting device access, the server provides access in accordance with the user operating the requesting device existing network access rights.

In one embodiment, the initial connection by a requesting device is limited to an isolated network segment with no access to network resources.

### BRIEF DESCRIPTION OF DRAWINGS

The features and advantages of the present invention will be better understood when the Detailed Description of the Preferred Embodiments given below is considered in conjunction with the figures provided, wherein:

FIG. 1 is a simplified block diagram of a conventional wireless local area network;

FIGS. 2A and 2B are a simplified block diagram of a wireless local area network (WLAN) constructed and operative in accordance with one embodiment of the present invention;

FIG. 3 is a flow diagram illustrating operations of application programming logic incorporating techniques, in accordance with one embodiment of the present invention, for automatically providing secure communications over the WLAN of FIGS. 2A and 2B; and

FIG. 4 depicts a security record, in accordance with one embodiment of the present invention.

In these figures, like structures are assigned like reference numerals, but may not be referenced in the description for all figures.

### DETAILED DESCRIPTION OF PREFERRED EMBODIMENTS

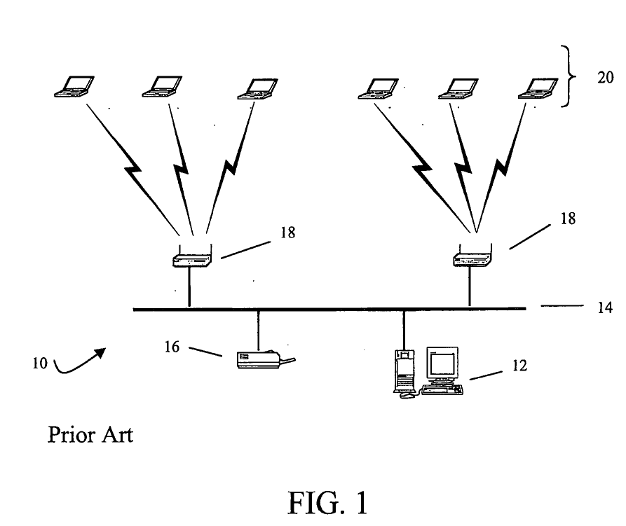

FIG. 1 illustrates a conventional wireless local area network (WLAN) 10. WLAN 10 includes a server module 12 connected via a wired communication bus 14 to peripheral devices such as, for example, a network laser printer 16. A plurality of wireless access points (APs) 18 are coupled to the communication bus 14 through a wired Ethernet connection. Wireless APs 18 are adapted to send and receive data to a plurality of wireless devices, shown generally at 20. The data include, for example, data content, requests for and receipt of server module-based services, and the like. Devices 20 include wireless-enabled computing devices such as, for example, laptop and notebook computers, personal digital assistants (PDAs), pagers and radio telephones, having wireless network interface cards (WNICs) installed therein.

Through manual setup and installation operations it is possible to transform WLAN 10 from its default Open System configuration to a secure Shared Key Mode configuration. Due to the amount of time and effort required for such manual implementation, however, this solution is practical only for very small networks. As a result, security in most wireless networks is not implemented, leaving them vulnerable to eavesdropping, unauthorized access, and a variety of other attacks.

The current state of the art allows for manual creation of encryption keys, which is not only laborious but is also considered to be insecure by the vast majority of data security experts due to the limitation of using one to four static encryption keys per wireless AP without frequently replacing them.

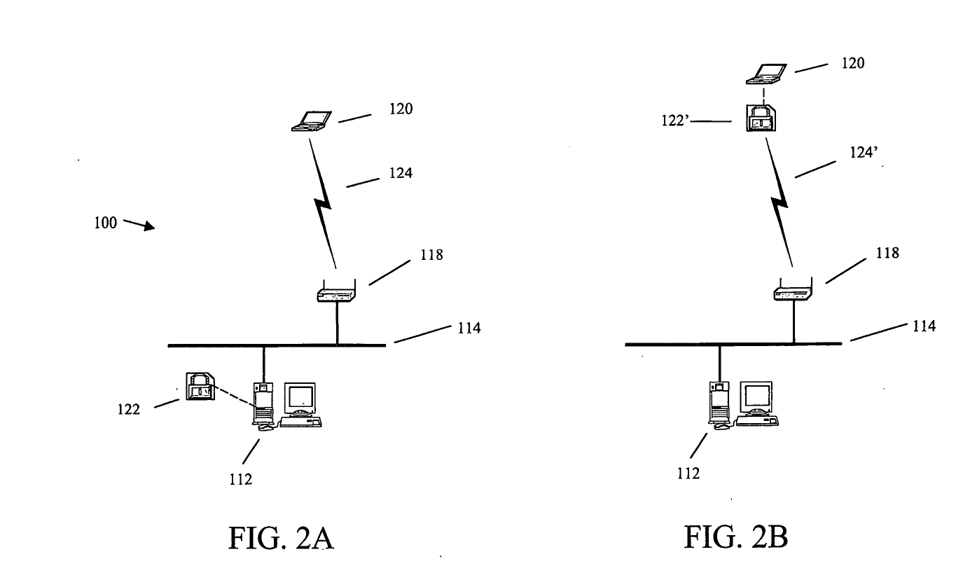

FIGS. 2A and 2B illustrate a wireless local area network (WLAN) 100 constructed and operative in accordance with one embodiment of the present invention. WLAN 100 includes a server module 112, a wired communication bus 114, and at least one wireless AP 118 coupled to communication bus 114 through a wired Ethernet connection. Wireless AP 118 is assigned a unique IP (Internet Protocol) address and is operative to send data to and to receive data from a plurality of wireless devices 120, such as a wireless-enabled laptop computer. The data are transmitted between wireless devices 120 and wireless AP 118 by way of radio frequency (RF), infrared (IR) signals or the like, illustrated in FIGS. 2A and 2B as signals 124 and 124′, respectively. Communication between wireless AP 118 and wireless devices 120 is conducted in accordance with a wireless data transmission protocol such as, for example, IEEE-802.11 Wireless LAN Medium Access Control and Physical Layer Specification, which is incorporated by reference herein in its entirety.

Wireless devices 120 communicate with other devices coupled to the WLAN 100 (e.g., server module 112) via wireless AP 118 and communication bus 114. Accordingly, wireless AP 118 is a bridge between the wireless devices and the devices coupled to the wired network (via communication bus 114). Security protocols executing on server 112 manage security of both wireless AP 118, which resides on the wired network, and wireless devices 120, which use wireless communications to access the wired network via wireless AP 118.

A software module 122, referred to herein as a Virtual Locksmith™ (VL), is resident on server module 112 (FIG. 2A), and is operative to function as an “intelligent software agent” to automatically carry out authentication and verification tasks as shall be described more fully below. When the user of wireless device 120 connects to network 100 for the first time via AP 118, VL 122 is automatically downloaded from server module 112 via wireless AP 118 and wireless channel 124 (unencrypted) to wireless device 120 and is automatically installed thereon (as illustrated in FIG. 2B at 122′). Once installed on wireless device 120, VL 122′ is operative to collect information about the particular wireless device and the user of the device. This information is automatically sent to server module 112 for verification and authentication. If, on the basis of the information collected by VL 122′, the user is authenticated, then server module 112 distributes encryption keys via VL 122′ to wireless device 120, and the user is allowed access to network 100 using an encrypted channel 124′ (FIG. 2B).

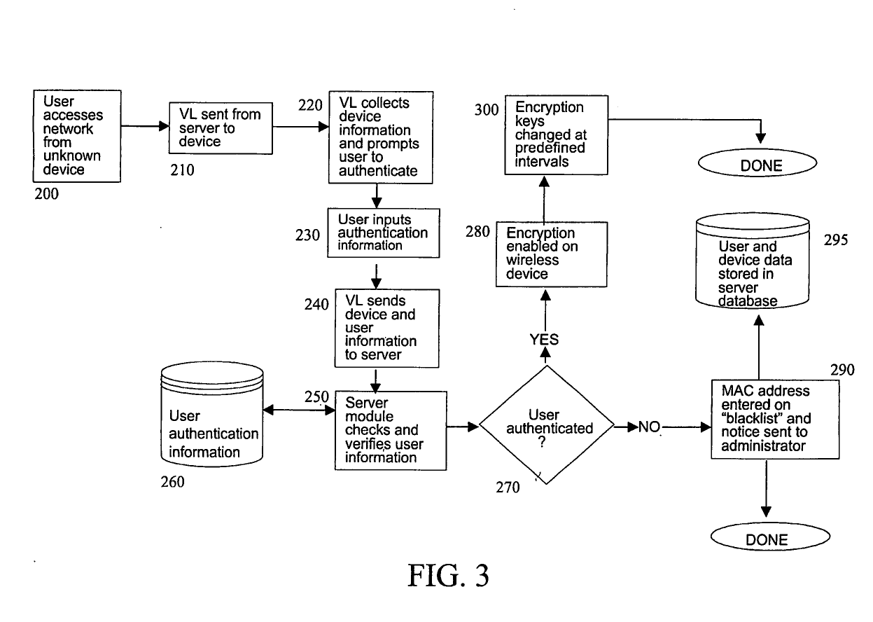

Referring now to the flow diagram of FIG. 3, an exemplary operation of the present invention may be appreciated. When a wireless network on which the present invention is implemented is first accessed by an unidentified user (Block 200), the Virtual Locksmith™ module is automatically downloaded from the network server to the user's wireless device (Block 210) and installed thereon. The VL module then collects device information and presents a logon screen, which may include a request for additional authentication information as defined by management and security personnel of the network (Block 220). The user then enters authentication information (Block 230) which may incorporate standard authentication methods such as, for example, Extensible Authentication Protocol (EAP), password authentication (PAP), Challenge Handshake Authentication Protocol (CHAP), and/or one-time passwords such as generated by RSA's SecureID™ product, or a social security number-taken from a data store of human resources information. In one embodiment, the authentication information may be input through a physical identification system employing a biometric device. The VL module then sends the device information and the user authentication information to the network server (Block 240) and this information is stored in a data store (Block 260) accessible by the server.

An authentication and verification process is then carried out on the server (Block 250) to verify the user's authorization credentials. The authorization credentials may include, but are not limited to, information such as user name, password, one-time password (e.g. a dynamic password used in products such as SecureID™), personal information, biometric identifier or any other user authentication technique.

In one embodiment, the network server may pass authentication input to supplemental authorization servers (not shown), such as network permissions applications, RADIUS authentication servers, and/or additional authorization servers as required. For example, customization may include requesting, in addition to user name and password, an additional piece of information such as a personal identification number. The server then passes the personal identification number to a data store (e.g., a Human Resource Department's database), and queries for verification of this user's personal identification number in the data store.

It will be appreciated that a wireless network operative in accordance with the present invention may also include a trusted network user access control mechanism for incorporating existing network permissions applications used to create, manage and maintain user names, passwords and other authorization credentials. Examples of such access control mechanisms include, for example, Novell's Directory Services™, Microsoft's Active Directory™ HP's Openview™ network permissions module, and the like. In accordance with the present invention, the network server interfaces with these products by relaying authorization information from users and querying these systems to validate authorized users. Validated users are granted access to the network (Blocks 280 and 300) while invalid users are disconnected and possibly added to a “Black List” (i.e., unauthorized access list) to prevent wireless access in the future (Block 290).

If the user is successfully authenticated during the initial communication, as described above, then the VL module on the user's device is automatically configured so as to provide encryption keys necessary for accessing the network (Block 280). When the authenticated user attempts to access the network on subsequent occasions, the user's device is recognized as a valid device, and access to the network is allowed. Typically, for enhanced security, the encryption keys are automatically changed (Block 300) at regular intervals, e.g., every ten minutes, in a process known as Key Rollover.

The user and device information is stored in a data storage device associated with the network server (Block 295) where it can interface with other enterprise applications such as a corporation's asset management application or an intrusion detection system (for tracking unauthorized users), in a manner generally known to those skilled in the art.

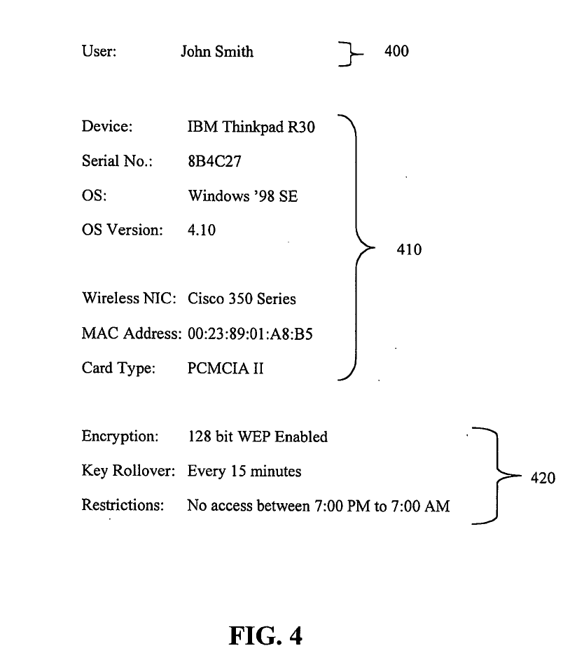

FIG. 4 provides an exemplary record of the type of information which may be stored in a data storage device of a wireless network operative in accordance with the present invention. As can be seen, the record may include user information (410) including user name, device information (420) including type, serial number and operating system of the device, and authentication rules (430). The authentication rules are utilized to implement any of a number of wireless security measures, such the Key Rollover period or access restrictions which may bar access during certain times of the day or to certain individuals or user groups within an organization.

As noted above, a wireless network operative in accordance with the present invention may include lists of both authorized and unauthorized users and/or devices. In conventional security systems, an access control table defining a list of permitted or excluded devices typically is stored in hardware at a wireless access point (AP). Typically, the access control table identifies devices by their MAC address which is unique to each WNIC. Generally speaking, in conventional systems the amount of included and excluded devices is limited to the number of lines in the access control table. Since it is stored in hardware, the amount of space varies from vendor to vendor and typically ranges between 16 and 256 devices per access point. It will be appreciated that this is not nearly enough capacity for the amount of devices in a typical corporate or public environment. The present invention overcomes this problem by dynamically creating, managing and maintaining lists of included and excluded devices. By employing dynamic access control list management, the system in accordance with the invention is able to overcome the limitation of devices imposed by current access table implementations. In one embodiment, device and user management is done via a centralized management console (not shown) associated with the network.

### Exemplary Applications

1. Billing—In the current state of the art, there are individuals, companies and institutions that offer access to wireless broadband services via public access networks, also know in the industry as Hot Spots. One of the biggest challenges to these service providers involves billing and reconciliation between disparate service providers. Examples of companies involved in providing these services include Boingo Wireless, One Point Networks and Wayport. In one implementation of the present invention, the VL module may be used to send a specific software application from the network server to a wireless device accessing the network and then to monitor the amount of time the user has accessed services provided by the application provider. At pre-defined intervals, the VL module sends a message to a central server about the amount of time those services were accessed; the central server stores the information and provides the usage information to companies participating in billing and reconciliation agreements.

2. Quality of Service—In the current state of the art, since disparate users on a computer network each have different computing requirements, efficient use of the computer network is facilitated through proper bandwidth allocation. Proper bandwidth allocation for both private and public networks is often referred to as Quality of Service (QoS). In wired networks, bandwidth allocation is typically handled by network routers connected to network interface cards. In wireless applications, it is difficult to measure bandwidth usage. In one implementation of the present invention, the VL module is operative to deliver a software application to the user's device which measures the amount of bandwidth consumed by the user. The bandwidth utilization information is then sent at pre-determined intervals to a central server where the information is forwarded to load balancing hardware for bandwidth allocation and ensuring of Quality of Service. Alternatively, some Internet Service Providers (ISPs) may want to charge customers according to bandwidth consumption, or charge customers who consume bandwidth above their agreed allotment. In such cases, bandwidth usage will be stored on the server and forwarded to a billing system in order to charge the customer.

3. Location of wireless users—In a highly mobile environment, employers may want to periodically check the location of their employees for reasons of both efficiency and security. In accordance with the present invention, the VL module may be operative to install a software application on each user's device which records the IP address of the user during specific Internet sessions. The IP address information is then sent to an IP address location system, which in the current state of the art charts IP addresses according their geographical location. This information is then stored in the server, thus giving the IT administrator a map of the last known location of mobile employees at a given time. Alternatively, the VL module may be operative to identify the access point through which the user is accessing the network, including its signal quality and direction, and to send this information to the server. The user's location may then be identified based upon the known location of the access point.

4. Software installation—There are many cases where IT departments in large companies may want to install one or more software programs specifically on the devices of wireless users. In one implementation of the present invention, the VL module is operative to simultaneously install one or more software programs located on the server, to multiple wireless clients.

5. Configuration—There are many cases where IT departments in companies want to have uniform configuration of wireless devices. These configuration parameters may include, but are not limited to, assignment of IP address, assignment of a wireless network name (also known as an SSID—Service Set Identifier) and determining of security method (WEP enabled or disabled, encryption key size of 64 or 128 bit, etc.). In one implementation of the present invention, the VL module is operative to download configuration information to one or more client devices in order to ensure proper configuration and make efficient use of IT resources.

6. Certificates—In some security methods, in order to establish mutual authentication between a server and a device, a “certification server” communicates with the device to determine whether or not the device has an appropriate certificate. The difficulty is that a certificate must be installed on each device. The process can be time-consuming and if not done in the proper manner, can also raise security issues. In one implementation of the present invention, the VL module is operative to both perform authentication, and if successful, install the certificate on the client device. Since the VL module creates an encrypted channel, as described above, the certificate is passed securely to the client device.

7. Isolated Network Segment—According to one embodiment of the present invention, the initial communication between the user and the network is restricted to an isolated network segment which is not connected to the rest of the network. Only after the user is authenticated and encryption keys enabled on his device is the user provided access to the rest of the network.

8. Security Policy—A Security Policy is a document which dictates the security regulations to be practiced for a specific company or organization. It is recommended by security experts that, as wireless communications become more ubiquitous, specific reference to Wireless Security Policy should be addressed as part of a general Security Policy document. In the current state of the art, it is very difficult to enforce a specific wireless security policy, since it is difficult to differentiate between wired and wireless users. In one implementation of the present invention, the VL module is operative to send a software application to the client (user device), which is capable of implementing a Wireless Security Policy. In one version of such a policy, an authenticated user may only access the wireless network from a single identified device. In this version, once an authorized user has successfully accessed the wireless network with identified device A, he will be denied access to the network if he attempts to access the network from device B.

In another version of a security policy, an authenticated user may be allowed access to the network from more than one device. Under such a policy, even though the user has previously accessed the wireless network from device A, he will be given a unique encryption key for device B and will be able to access the network both from device A and from device B. Optionally, when the user accesses the network from the second device, an alert may be sent to appropriate management and security personnel for additional verification and control.

In yet another version of a security policy, multiple authenticated users may be allowed to use shared identified devices to access the wireless network. For example, a user X may have accessed the wireless network with identified device A, and a user Y may have accessed the wireless network with identified device B. According to this security policy, the authenticated users may share the identified devices. Therefore, if user X attempts to access the network with device B, he will be provided access using the encryption keys for device B, although his access rights will be limited to those granted to him, and not those granted to user Y.

9. Guest Users—In yet another version of a security policy that may be implemented in accordance with the present invention, guest users may use unidentified devices and are granted guest permission for accessing the wireless network. Currently, when a visitor to a company or organization needs to check his email or have Internet access to cull information from the World Wide Web, typically he is only allowed to physically connect his portable computer to a wired network using a standard wired Ethernet connection. This is both time consuming and poses certain security risks by allowing the visitor access to the company or organization's network. In accordance with one implementation of the present invention, the VL module may be operative to provide the visitor with a temporary encryption key and to identify the visitor's device as a guest device. This information may be stored on the network server and used later for verification the next time the guest user or guest device attempts to access the wireless network. The security policy of the company or organization may dictate that the guest user is barred from accessing the wireless network a second time, and in such event the guest will be denied access and his device placed on the unauthorized list. Alternatively, the security policy may allow the visitor to regain access to the wireless network, but only after confirmation by a system administrator who has received an alert concerning the attempted access to the network.

While the present invention has been described and illustrated in connection with preferred embodiments, many variations and modifications will be evident to those skilled in the art, and may be made without departing from the spirit and scope of the invention as described herein. The invention is thus not limited to the precise details of methodology or construction set forth above but includes all variations and modifications within the scope of the claims.

1. In a wireless network comprising a server and server software including an intelligent software agent, a method of automatically providing a secure connection between the wireless network and a user-operated device seeking access to the wireless network, the method comprising:
in response to an initial request for access to the wireless network by the device—
(a) automatically installing the software agent on the device;
(b) executing the software agent on the device to gather information from the requesting device, including device information and user authentication information;
(c) transmitting the device identification and user authentication information to the server; and
(d) verifying the device identification and user authentication information;
wherein when successfully verified, storing the identification and authentication information on an authorized access list, providing a unique encryption key to the device for storage thereon and granting the requesting device access to the wireless network; and when unsuccessfully verified, storing the identification and authentication information on an unauthorized access list and denying the device access to the wireless network.

2. The method of claim 1 further comprising, in response to a subsequent request for access to the wireless network by the device—
(a) receiving the unique key corresponding to the device;
(b) retrieving the identification and authentication information corresponding to the unique key;
(c) comparing the identification and authentication information with the authorized and unauthorized lists; and
(d) based on the comparison, one of granting and denying the device access to the wireless network.

3. The method of claim 1, wherein the step of denying access comprises generating a notification message that an unauthorized device has attempted to access the network.

4. The method of claim 1, wherein the step of granting access comprises providing access in accordance with existing network access rights of the user operating the device.

5. The method of claim 1, further comprising the step of collecting information relevant for billing the user for services accessed through the network.

6. The method of claim 1, further comprising the step of collecting information relevant for bandwidth allocation over the network.

7. The method of claim 1, further comprising the step of determining the geographical location of the device.

8. The method of claim 1, further comprising the step of automatically installing application software on the device.

9. The method of claim 1, wherein the encryption key is a certificate.

10. The method of claim 1, wherein the network comprises an isolated network segment and the initial connection between the device and the network is limited to the isolated network segment.

11. The method of claim 1, wherein the step of granting access further comprises conformity to a security policy with respect to access from multiple devices.

12. The method of claim 1, wherein the user is defined as a guest user and given a temporary encryption key with guest network access rights.
